(19) United States
(12) Patent Application Publication
(10) Pub. No.: US 2011/0265761 A1
(43) Pub. Date: Nov. 3, 2011

(54) Method and related system of dithering spark timing to prevent pre-ignition in internal combustion engine

(75) Inventors: Manfred Amann, San Antonio, TX (US); Terrence F. Alger, II, San Antonio, TX (US)

(73) Assignee: Southwest Research Institute, San Antonio, TX (US)

(21) Appl. No.: 12/799,753

(22) Filed: Apr. 30, 2010

(51) Int. Cl. F02P 5/04

(52) U.S. Cl. 123/406.11

(57) ABSTRACT

Methods of mitigating the occurrence of a low-speed pre-ignition event in a multi-cylinder internal combustion engine (10), the engine (10) having a computerized engine management control module (70) and an ignition timing module (66) controllable by the engine management control module (70). The computerized engine management module (70) monitors the operating conditions of the internal combustion engine (10) and at certain operating conditions dithers the ignition timing of at least one cylinder (20) of the engine (10) to induce light to medium SI engine knock temporarily. Due to the high temperature, high frequency pressure waves caused by SI engine knock, fuel and/or lubricant related deposits accumulated on combustion chamber components, i.e. top piston land crevices or piston crown, are consumed so that said deposits (60) cannot become a source of pre-ignition

### TECHNICAL FIELD

Embodiments are generally related to improved automotive engine performance. Embodiments also relate to the field of improved combustion cycles in a flame propagation engine, such as an internal combustion engine. In addition, embodiments relate to preventing a low speed pre-ignition event by adjusting the spark timing of at least one cylinder in multi-cylinder spark ignition engine.

### BACKGROUND OF THE INVENTION

Pre-ignition in a flame propagation (or “spark-ignition” as the terms will be used interchangeably throughout) engine describes an event wherein the air/fuel mixture in the cylinder ignites before the spark plug fires. Pre-ignition is initiated by an ignition source other than spark, such as hot spots in the combustion chamber, a spark plug that runs too hot for the application, or carbonaceous deposits and/or engine lubricant related deposits (calcium or barium salts, etc.) in the combustion chamber heated to incandescence by previous engine combustion events. Many passenger car manufacturers have observed intermittent pre-ignition in their production turbocharged gasoline engines, particularly at low speeds and at medium-to-high loads. At these elevated loads, pre-ignition usually results in severe engine knock, loss of performance and engine mechanical damages.

It is believed the auto-ignition of oil droplets and/or fuel-oil mixture droplets that accumulate in the piston top land area are one of the leading causes for this low-speed pre-ignition phenomenon. It is also believed that small amounts of oil may be transferred from below the oil control ring to the piston top land area due to unusual piston ring movement. At low speeds, in-cylinder pressure dynamics (compression and firing pressures) are somewhat different at high load conditions than they are at lower loads due to strongly retarded combustion phasing and high boost as well as peak compression pressures which can influence ring motion dynamics. Other possible sources of pre-ignition are believed to be soot deposits and/or lubricant related deposits (calcium or barium salts, etc.) accumulating inside the combustion chamber and localized air/fuel mixture auto-ignition

Pre-ignition can sharply increase combustion chamber temperatures and lead to rough engine operation or loss of performance. Traditional methods of eliminating pre-ignition are available and include proper spark plug selection, combustion chamber design improvements, proper fuel/air mixture adjustment, and improved oil and fuel additives that reduce combustion chamber deposit formation.

Given that most modern day automotive engines are equipped with onboard computerized engine management systems, a means of preventing pre-ignition, in particular low-speed pre-ignition, before it happens would be advantageous. Ideally, engine parameters could be adjusted during normal operation of the vehicle's engine so that the source(s) contributing to a low-speed pre-ignition event could be countered. Therefore, a way eliminating sources of pre-ignition by altering engine performance during normal operating conditions would be highly advantageous and allow the engine management system to take steps to prevent or mitigate the event before it occurs.

### SUMMARY OF THE INVENTION

The present invention provides methods and a related system of dithering the ignition timing of a modern day internal combustion engine in order to the consume oil, oil/fuel droplets and other deposits which are believed to be a source of pre-ignition.

According to one embodiment, disclosed is a method of preventing a pre-ignition event in a spark ignition engine. The method comprises the steps of operating a spark ignition engine under normal operating conditions. Next, the timing of spark occurrences is dithered within at least one combustion chamber of the spark ignition engine so that light to medium SI engine knock is induced temporarily. Due to the high temperature, high frequency pressure waves cause by knock, deposits within the combustion chamber are substantially consumed during this period and, thus, pre-ignition can be prevented.

According to another embodiment, disclosed is a method of mitigating the occurrence of a low-speed pre-ignition event in a multi-cylinder internal combustion engine, the engine having a computerized engine management control system and an ignition timing system controllable by the engine management control system. The method comprises the step of the computerized engine management system monitoring the operating conditions of the internal combustion engine. Next, once certain operating conditions are detected, the computerized engine management system dithers the ignition timing of at least one cylinder of the internal combustion engine and the computerized engine management returns the ignition timing of the cylinder to a calibrated condition so that deposits in the combustion chamber of the cylinder are substantially consumed to prevent a pre-ignition of said deposits. The engine management control system may also dither the timing of all cylinders one at a time so that deposits in all cylinders of the engine are substantially consumed.

Also disclosed is a system for mitigating the occurrence of a low-speed pre-ignition event in a multi-cylinder internal combustion engine. The system comprises an engine management control module comprising hardware and software for adjusting various engine performance parameters of the engine. The system further comprises a spark ignition control module for causing a spark within the combustion chamber of each cylinder of the engine. A first set of software coded instructions is provided for causing the engine management control module to control the spark ignition control module to dither the timing of sparks generated by the spark ignition control module so that combustion chamber deposits are substantially consumed to prevent a pre-ignition of the deposits. The system further comprises a second set of software coded instructions for causing the engine management control module to control the spark ignition control module to return the ignition timing of the cylinders to a calibrated condition.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates an example spark ignition engine coupled to an engine control module and spark ignition control module using a knock sensor for adjusting the spark timing of the engine according to one embodiment of the invention;

FIG. 2 is a block diagram of a system for mitigating a low-speed pre-ignition event according to one embodiment; and

FIG. 3 is a process flow diagram illustrating a method of mitigating the occurrence of a low-speed pre-ignition event in a spark ignition engine according to one embodiment.

### DETAILED DESCRIPTION

The particular values and configurations discussed in these non-limiting examples can be varied and are cited merely to illustrate at least one embodiment and are not intended to limit the scope thereof.

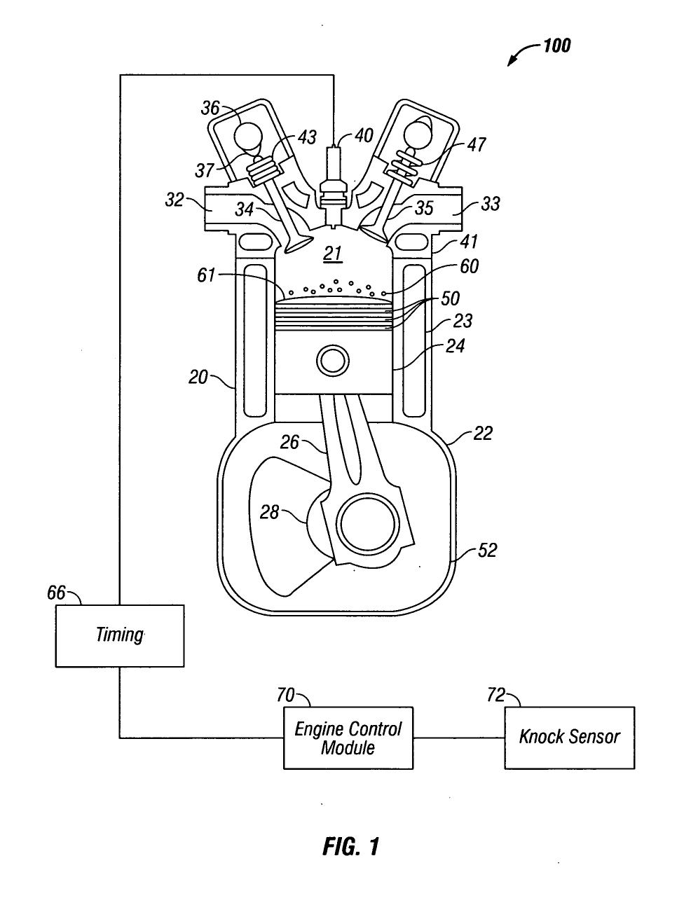

With reference to FIG. 1 a spark ignition engine according to a first embodiment of the invention is shown and denoted generally as 10. Engine 10 includes a cylinder 20 coupled to crankcase 22. A piston 24 travels within up and down within the combustion chamber 21 of cylinder 20 and is connected to a crankshaft 28 via a piston rod 26. The cylinder 20 is attached to the crankcase 22 which houses the crankshaft 28. The underside of the piston 24 and the crankcase 22 forms a crankcase volume that will vary as the piston 24 moves up and down within the combustion chamber 21.

Engine 10 is supplied an air/fuel mixture through intake passageway 32. The air/fuel mixture is supplied to the combustion chamber 21 by the operation of intake valve 34 which, in turn, is opened and closed by the rotation of camshaft 36 and cam 37 with the assist of spring force provided by spring 43. A spark plug 40 provides the energy necessary to ignite the air/fuel mixture which combusts inside the combustion chamber 21 causing piston 24 to move downward in the direction of crankcase 22 resulting in the rotation of crankshaft 28. The resulting exhaust vapors exit through passageway 33 as exhaust valve 35 opens. Valves 34 and 35, passageways 32 and 33, and spark plug 40 are typically part of the upper portion of a 4 cycle internal combustion engine, such as engine 10, commonly referred to as the head 41.

Engine lubricant 52 is maintained in a portion of the volume defined by crankcase 22. A set of piston rings 50 are used to seal the combustion chamber 21 from the crankcase 22, to support heat transfer from the piston 24 to the walls of the cylinder 20, and to regulate the consumption of engine lubricant 52. Passage 23 provides a path for coolant to travel for the extraction of engine heat.

In most internal combustion engines it is common for oil and/or fuel droplets, soot and/or other engine deposits 60 to accumulate in the piston top land area 61 under normal operating conditions. One source of such deposits is believed to be the transfer of small amounts of oil from below the piston rings 50 to the piston top land area 61 due to unusual movements of the piston rings 50 which often lead to increased in-cylinder pressure blow-by as well as increased transfer of engine lubricant 52 to the combustion chamber 21. Another source is believed to be oil and/or fuel related deposit that accumulate on the piston top. The accumulation of deposits 60 often leads to undesirable conditions which negatively impact engine performance and efficiency. Specifically, deposits 60 provide a source of pre-ignition since deposits 60 inside the combustion chamber are believed to initiate combustion prior to normal spark timing.

Therefore, the present invention provides a method of preventing a pre-ignition event in a spark ignition engine by altering or “dithering” the timing of spark occurrences within the combustion chamber 21 so that deposits 60 within the combustion chamber 21 are substantially consumed to prevent a pre-ignition of the deposits 60. The inventors of the present invention have discovered that by dithering the ignition timing, the accumulated deposits 60 can be burned off, broken up and otherwise consumed. As shown, a spark ignition control module 66 controls the ignition timing of spark plug 40 so that the timing can be adjusted as compared to normal engine calibration conditions. Spark ignition control module 66 is shown coupled to engine management control module 70 which can comprise a typical onboard computer found in modern day automobiles. Engine management control module 70 receives input from knock sensor 72. In this way, ignition timing can be varied to induce a predefined level of knock during the dithering process. This predefined level of knock (as determined by engine knock sensor 72 and engine management control module 70) can be varied from engine to engine and be part of the engine calibration process. It should be understood, however, that the invention contemplates other ways of dithering the timing of spark ignition as will be apparent to those of ordinary skill in the art.

Thus, in one embodiment, engine 10 is operated with a light to medium engine knock through the advancement of ignition timing by ignition control module 66 and at engine operating conditions where low-speed pre-ignition is typically observed, to reduce the likelihood of low-speed pre-ignition. To achieve this, spark timing would be dithered periodically, where it is advanced from engine calibration conditions based on spark timing for a short period. In one embodiment, the period of advancement is less than 100 consecutive engine cycles or less than 2 seconds. Preferably, the amount of advancement should be sufficient to induce light engine knock. Knock sensor 72 can be used to gauge the level of engine knock. In another embodiment, spark timing is advanced in the neighborhood of 1-10 crank angle degrees.

In addition, the frequency at which spark timing is dithered may vary dependent on engine operating conditions, such as speed and load. Thus, spark timing frequency can be set during engine calibration. To reduce noise, vibration and harshness (NVH) related issues caused by engine knock, the spark timing dither strategy could be rotated through all cylinders to where only one cylinder is operated with light knock at a time. Alternatively, spark timing could be set to where low levels of knock are induced continuously in all cylinders. Engine knock sensor 72 can be use to detect the amount of engine knock. However, because of the danger of causing damaged to combustion chamber components, this method might be less practical.

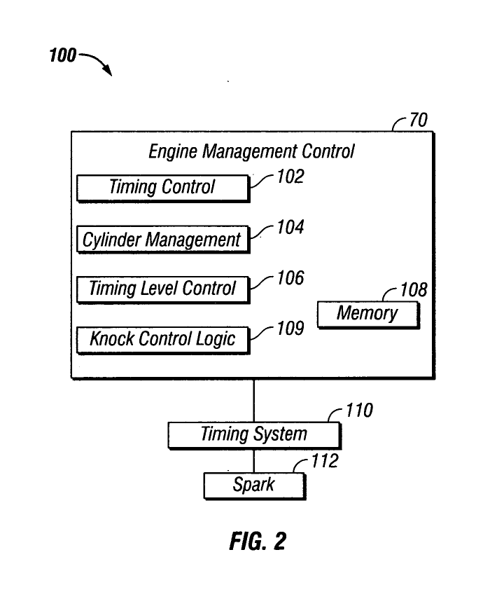

Referring to FIG. 2, a block diagram of a system 100 for mitigating a low-speed pre-ignition event in a spark ignition engine according to one embodiment of the invention is shown. System 100 is shown to include an engine management control module 70 supporting timing control functions 102, cylinder management functions 104 and timing level control functions 106. Preferably, engine control module 70 comprises the hardware and software required to diagnose, implement and adjust various engine conditions such as, for example, advancing or retarding spark ignition in order to cause a spark ignition engine, such as engine 10, to substantially consume engine deposits. As is apparent to those of ordinary skill, engine control module 70 could be readily implemented as part of a vehicle's onboard computer system which is commonly employed in modern day automobiles. Thus, the implementation of the control module 70 according to the invention can be easily incorporated into modern automotive designs.

In one embodiment, control module 70 includes a set of software coded instructions which can be stored in memory 108 in which the functions of a system for mitigating a low-speed pre-ignition event according to invention are implemented. For example, software coded instructions could be written and stored in the memory 108 in order a to cause the engine management control module 70 to control the timing module 102 which via timing system 110 which, in turn, causes spark 112 to ignite. In this way, spark timing is dithered so that combustion chamber deposits are substantially consumed to prevent a pre-ignition of said deposits.

Memory 108 can further store the software coded instructions for causing the engine management control module 70 to control the spark within the various cylinders of a multi-cylinder spark ignition system via cylinder management module 104. In addition, software code instructions for controlling the level of ignition timing 106 can also be stored in the memory module 108 of the engine management control module 70. Part of the control logic of control module 70 can be used to communicate with engine knock sensor 72 for receiving feedback indicating engine knock, as indicated by knock control logic 109. Thus, the ignition timing could be varied to induce a predefined level of knock during the dithering process. This predefined level of knock can vary from engine to engine and may be part of the engine's calibration process.

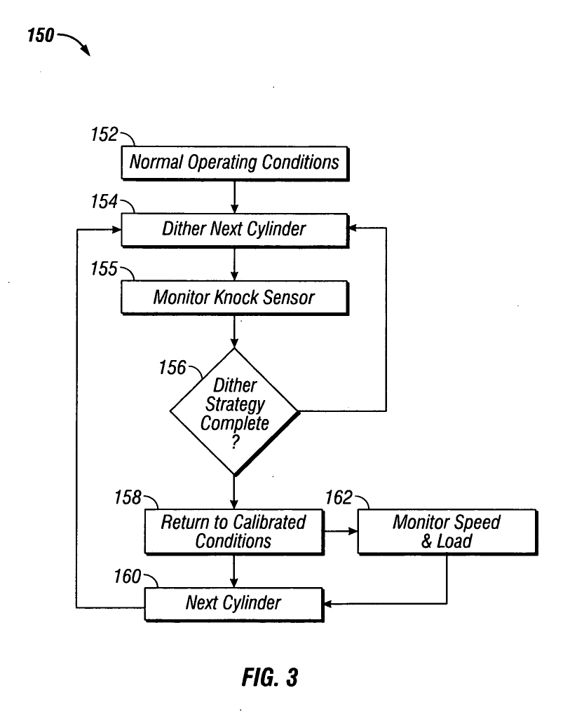

In FIG. 3, a process flow diagram for a method 150 of mitigating the occurrence of a low-speed pre-ignition event in a spark ignition engine is shown. Process flow begins at step 152 where a spark ignition engine is run under normal operating conditions where standard calibrated ignition timing across all cylinders of a multi-cylinder engine is employed. Next, at step 154, the timing of at least one cylinder is dithered by, for example, advancing the timing for period of 100 or so engine cycles or no longer than 2 seconds. Of course, it should be readily understood that other dithering strategies may be employed according to engine load and speed conditions and/or vehicle type and application. By dithering timing of at least one cylinder, step 154, light to medium SI engine knock is induced temporarily to initiate the consumption of aforementioned engine deposits so that they cannot become a source of pre-ignition.

Engine knock can be monitored, step 155, to determine if a predefined amount of engine knock has been achieved through dithering of the ignition timing. Once the ignition timing has been dithered for the specified number of engine cycled as determined at step 156, the engine control module can then return the ignition timing of the affected cylinder back to calibrated engine conditions, step 158. Next, the engine control module can dither the timing of the next cylinder, step 160. If timing adjustments of the next cylinder have been in place a sufficient number of engine cycles, it is determined if all cylinders have had their timing advanced and, if so, engine timing is returned to calibration. The engine module can continue to monitor engine conditions, step 162, to determine if more dithering should be employed and, if so, process flow may be directed back to step 154. Also; an alternative timing strategy can be employed, that varies ignition timing of the engine according to speed and load conditions.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of preventing a pre-ignition event in a spark ignition engine comprising the steps of:
running a spark ignition engine under normal operating conditions; and
dithering the timing of spark occurrences within at least one combustion chamber of the spark ignition engine to induce light to medium SI engine knock temporarily so that deposits within the combustion chamber are substantially consumed to prevent said deposits from becoming a source of pre-ignition.

2. The method of claim 1 wherein said altering step comprises advancing the ignition timing.

3. The method of claim 2 further comprising the step of advancing the ignition timing for a period of no longer than 5 seconds.

4. The method of claim 2 further comprising the step of advancing the ignition timing for less than 200 consecutive engine cycles.

5. The method of claim 2 further comprising the step of advancing the ignition timing sufficiently to induce light to medium SI engine knock.

6. The method of claim 2 further comprising the step of advancing the ignition timing in the range of 1-10 crank angle degrees.

7. The method of claim 2 further comprising the steps of:
monitoring the speed and load of the spark ignition engine; and
varying the ignition timing in relation to the speed and load of the spark ignition engine.

8. The method of claim 1 further comprising the step of adjusting the ignition timing of each combustion chamber in rotation.

9. A method of mitigating the occurrence of a low-speed pre-ignition event in a multi-cylinder internal combustion engine, the engine having a computerized engine management control system and an ignition timing system controllable by the engine management control system, the method comprising the steps of:
the computerized engine management system monitoring the operating conditions of the internal combustion engine;
once certain operating conditions are detected, the computerized engine management system dithering the ignition timing of at least one cylinder of the internal combustion engine to induce light to medium SI engine knock temporarily; and
the computerized engine management returning the ignition timing of said cylinder to a calibrated condition;
wherein deposits in the combustion chamber of said one cylinder are substantially consumed to prevent said deposits from becoming a source of pre-ignition.

10. The method of claim 9 further comprising the step of dithering the timing of all cylinders of said internal combustion engine one at a time so that deposits in all cylinders of the engine are substantially consumed.

11. The method of claim 10 wherein said dithering step is achieved by advancing the ignition timing of said internal combustion engine.

12. The method of claim 11 further comprising the step of advancing the ignition timing for a period of no longer than 5 seconds.

13. The method of claim 11 further comprising the step of advancing the ignition timing for less than 200 consecutive engine cycles.

14. The method of claim 11 further comprising the step of advancing the ignition timing sufficiently to induce light to medium SI engine knock.

15. The method of claim 11 further comprising the step of advancing the ignition timing in the range of 1-10 crank angle degrees.

16. The method of claim 11 further comprising the steps of:
monitoring the speed and load of the spark ignition engine; and
varying the ignition timing in relation to the speed and load of the spark ignition engine.

17. A system for mitigating the occurrence of a low-speed pre-ignition event in a multi-cylinder internal combustion engine comprising:
a engine management control module comprising hardware and software for adjusting various engine performance parameters of the engine;
a spark ignition control module for causing a spark within the combustion chamber of each cylinder of the;
an engine knock sensor coupled to the engine management control module for providing engine knock feedback signals;
a first set of software coded instructions for causing said engine management control module to control said spark ignition control module to dither the timing of sparks generated by said spark ignition control module so that combustion chamber deposits are substantially consumed to prevent a pre-ignition of said deposits; and
a second set of software coded instructions for causing said engine management control module to control said spark ignition control module to return the ignition timing of said cylinders to a calibrated condition.

18. The system of claim 17 further comprising a third set of software coded instructions for monitoring the speed and load of the spark ignition engine and varying the ignition timing in relation to the speed and load of the spark ignition engine.

19. The system of claim 17 wherein said first set of software coded instructions dither the timing of sparks by advancing the ignition timing of said internal combustion engine.

20. The system of claim 17 wherein said first set of software coded instructions dither by advancing the ignition timing sufficiently to induce light to medium SI engine knock.
